(19) United States
(12) Patent Application Publication
(10) Pub. No.: US 2009/0183447 A1
(43) Pub. Date: Jul. 23, 2009

(54) Apparatus and methods for protecting an opening of a structure

(75) Inventors: Henry M. Hay, III, Charleston, SC (US); Bruce A. Weber, Summerville, SC (US)

Correspondence Address: NELSON MULLINS RILEY & SCARBOROUGH, LLP, 1320 MAIN STREET, 17TH FLOOR, COLUMBIA, SC, 29201, US

(73) Assignee: The Muhler Company, North Charleston, SC (US)

(21) Appl. No.: 12/009,489

(22) Filed: Jan. 18, 2008

(51) Int. Cl. E06B 3/30

(52) U.S. Cl. 52/202; 52/741.3

(57) ABSTRACT

A novel storm resistant shutter, the shutter having a front side and a back side and comprising a wood structural panel and a protective coating that includes a surface configuration having the appearance of a decorative shutter.

### BACKGROUND OF THE INVENTION

The present invention relates generally to an apparatus and methods for protecting an opening of a structure.

Protection of glass window and door panes in buildings during storms has been a great problem in the past. Many efforts have been made to prevent the glass panes from shattering and being driven into a building due to high winds, projectiles, and debris caused by storms, thereby damaging the interior of the building through the breached glass pane.

Presently, home and business owners who seek to minimize the damage caused by severe storms have few options for protecting windows and doors. Some of these options can prove to be very expensive and can require time-consuming installation. One such option requires the installation of metal storm shutters, which are either removable or can be rolled up over an opening for storage and rolled down for deployment and protection. Such shutters, however, are expensive and often require installation by professionals.

In some situations, to avoid more expensive methods, tape is applied directly to windows so that glass shards are not blown into the structure if the window breaks during a storm. This method provides little protection from the storm itself and the tape is difficult to remove. Often, the tape leaves an unsightly residue on the windows or doors after removal.

Another common option is buying and cutting pieces of plywood and affixing them over each window. There are, however, many disadvantages to this practice. A storm can escalate very quickly, leaving structure owners with only a little time to prepare, and the owner may not have enough time to cut each piece of plywood to the proper specifications and affix it in place. Furthermore, plywood is heavy and requires considerable effort to lift the plywood over the opening and also to secure it there.

Additionally, plywood is susceptible to rot, so it is often difficult or impossible to repeatedly store and use the plywood sheets during subsequent storms. This necessitates buying more pieces of plywood before each storm. An additional problem is that many hardware stores run out of plywood during storms because so many people in the area use it for window protection, leaving some structure owners with little or no protection during a storm.

### SUMMARY OF THE INVENTION

Briefly therefore, the present invention is directed to a novel storm resistant shutter, the shutter having a front side and a back side, the shutter comprising: a wood structural panel and a protective coating that includes a surface configuration having the appearance of a decorative shutter.

The present invention is also directed to a novel storm resistant shutter for protecting an opening of a structure, the shutter having a front side that faces toward the structure and a back side that faces away from the structure when the shutter is closed to protect the opening, the shutter comprising: a plywood panel having a width that is at least ½ of the width of the opening and which is longer than the opening and a thickness of between about 7/16 inches; a protective coating comprising expandable polyurethane foam and a mesh formed from polyester fibers that encloses the plywood panel and has a surface configuration having the appearance of a decorative shutter; and mounting fittings that are attached to the shutter and located for swingably attaching the shutter to the structure such that the shutter can be positioned in both an open and in a closed position covering the opening; and one or more connectors for releasably securing the shutter to the structure in a closed position covering the opening.

The present invention is also directed to a novel method for protecting an opening of a structure from wind gusts and wind-borne debris, the method comprising: swingably attaching to the structure a shutter that can be positioned in both an open and a closed position to at least partially cover the opening, wherein the shutter has: a front side that faces toward the structure and a back side that faces away from the structure when the shutter is closed to protect the opening; a wood structural panel having a width that is at least ¼ of the width of the opening to be protected and a thickness of between about 0.5 and 1 inches; and a protective coating applied to at least one side of the wood structural panel; closing the shutter to at least partially cover the opening; and securing the shutter directly to the structure with at least one connector so that the shutter covers at least a portion of the opening when the shutter is closed.

The present invention is also directed to a novel method of storing a shutter for protecting an opening of a structure, the method comprising: providing a shutter which comprises: a wood structural panel; a protective coating that includes a surface configuration having the appearance of a decorative shutter; and mounting fittings for swingably attaching the shutter adjacent the opening; swingably attaching the shutter adjacent an opening of a structure in a location that it remains adjacent to the opening when the shutter is not closed to cover the opening; and securing the shutter in an open position.

The present invention is also directed to a novel method for producing a storm resistant shutter, the method comprising: providing a wood structural panel having a front sides and a back side; and applying a protective coating to the panel, wherein the coating includes a surface configuration having the appearance of a decorative shutter.

### BRIEF DESCRIPTION OF THE DRAWINGS

FIG. 1 shows a front view of an embodiment of the present invention in which two shutters 10 and 10′ are swingably attached to opposite, longitudinal sides of an opening 20 of a structure 21 and are in an open position;

FIG. 2 shows (A) a front view, and (B) a side, cross-sectional view of an embodiment of the present invention where two shutters 10 and 10′ are swingably attached to opposite, longitudinal sides of an opening 20 of a structure 21 and are in a closed position;

FIG. 3 shows (A) a front view, (B) a side, cross-sectional view, and (C) a top, cross-sectional view of an embodiment of a shutter 10 of the present invention with a raised panel surface design 70;

FIG. 4 shows (A) a front view, (B) a side, cross-sectional view, and (C) a top, cross-sectional view of an embodiment of a shutter 10 of the present invention with a louvered surface design 70;

FIG. 5 shows (A) a front view, (B) a side, cross-sectional view, and (C) a top, cross-sectional view of a corner of an embodiment of a shutter 10 in accordance with the present invention;

FIG. 6 shows (A) a front view, (B) a side, cross-sectional view, and (C) a top, cross-sectional view of a corner of an embodiment of a shutter 10 of the present invention with a louvered surface design 70 that contains a hinge 91 which is connected to a structure 21;

FIG. 7 shows a front view of an embodiment of the present invention in which two bi-fold shutters 10 and 10′ are attached to the opening 20 of a structure 21; and

FIG. 8 shows a front view of an embodiment of the present invention in which a Bahama shutter 10 is swingably attached to the upper longitudinal side 111 of an opening 20 of a structure 21 and is elevated on the lower longitudinal side 112 of the opening 20.

The following detailed description is to be read with reference to the drawings, in which like elements in different drawings have like reference numbers. The drawings, which are not necessarily to scale, depict selected embodiments and are not intended to limit the scope of the invention.

### DETAILED DESCRIPTION OF THE PREFERRED EMBODIMENTS

In accordance with the present invention a novel shutter has been discovered that can be used for protecting an opening of a structure, and in particular, a glazed opening. The shutter has a front side, which in some installations faces toward the structure and a back side that faces away from the shutter when the shutter is closed to protect the opening. The shutter includes a wood structural panel and a protective coating that includes a surface configuration having the appearance of a decorative shutter.

When the shutter includes a wood panel having a thickness between about 0.1 inches and 2 inches, the novel shutter can be used to protect an opening of a structure from wind and wind-borne debris resulting from wind gusts up to 130 miles per hour, or even up to 150 miles per hour, by securing the shutter to the structure with connectors so that the one or more of the shutters cover at least a portion of the opening when the shutter is closed. Preferably, the shutters cover the entire opening. In a typical installation, two of the novel shutters are swingably mounted with hinges on either side of an opening, such as a window, and when the shutters are open, they present the pleasing appearance of conventional decorative shutters. And yet, the novel shutters can be closed and secured over the opening to provide protection that meets building code requirements for protective wind-borne debris protection devices at a fraction of the cost of conventional code compliant storm windows or storm shutters.

The novel shutters can be used to protect an opening in any type of structure 21. For example, the structure can be a one or two-story building. Alternatively, the structure can be one having a mean roof height of 33 feet or less.

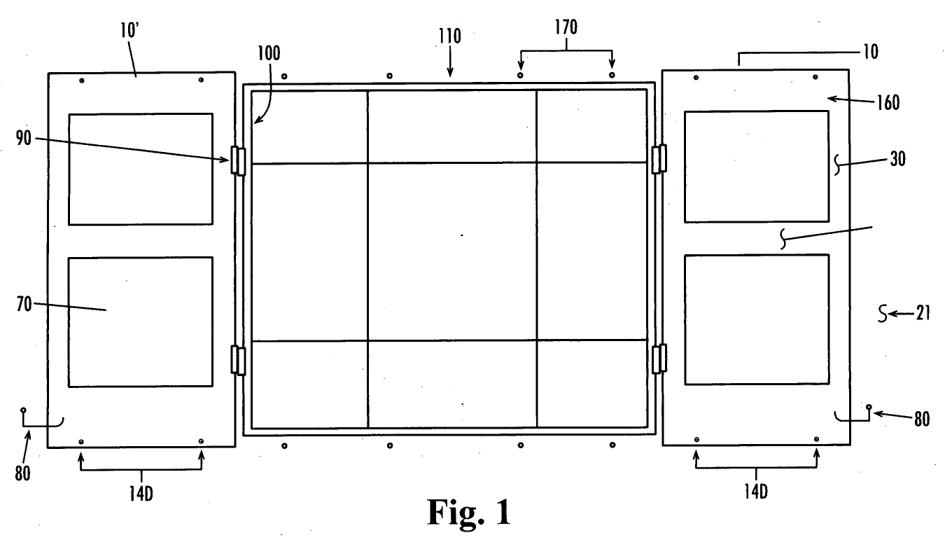

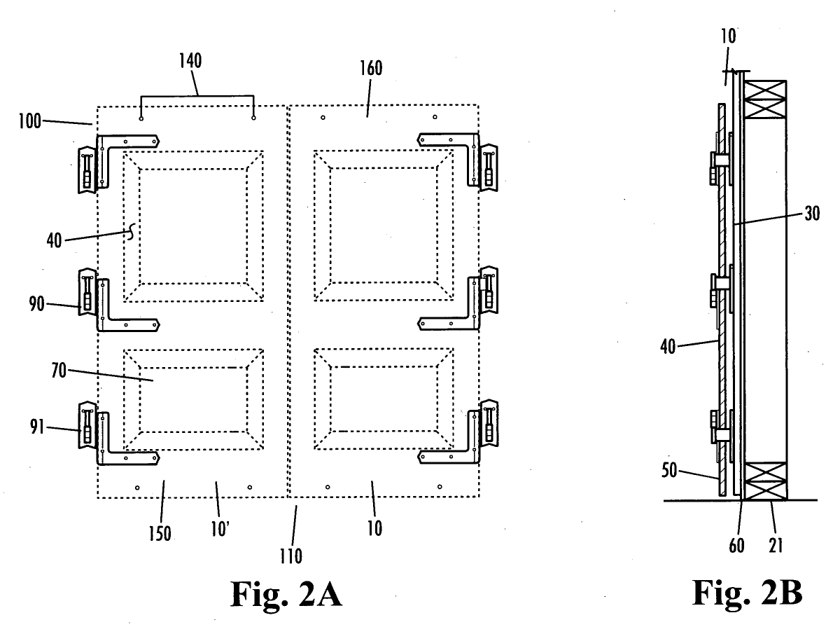

In one aspect, the present invention is a shutter 10 that can be used to protect the opening 20 of a structure 21. In one aspect, as depicted in FIG. 1, shutters 10 and 10′ are deployed in an open position where each shutter has a front side 30 that faces away from the structure 21 and a back side 40 that faces toward the structure 21 when the shutters are in the open position. As depicted in FIG. 2A, shutters 10 and 10′ are shown in a closed position where each has a front side 30 that faces toward the structure 21 and a back side 40 that faces away from the structure 21 when the shutter 10 is closed to protect the opening 20.

The opening 20 to be protected may be any opening of a structure. Typically the opening is a glazed opening in the exterior surface of the structure. For example the opening 20 may be a window, a door, or a skylight. However, the novel shutter can be used to protect any glazed opening that is subject to wind and/or storm damage. When the opening 20 is described herein as having a length and a width, what is meant is the longitudinal and latitudinal dimensions of the face of the opening. When referring to a window on a vertical wall, the length of the opening is the vertical dimension of the window opening and the width is the horizontal dimension of the window opening. It is preferred that the width and length of the opening each not exceed 8 feet.

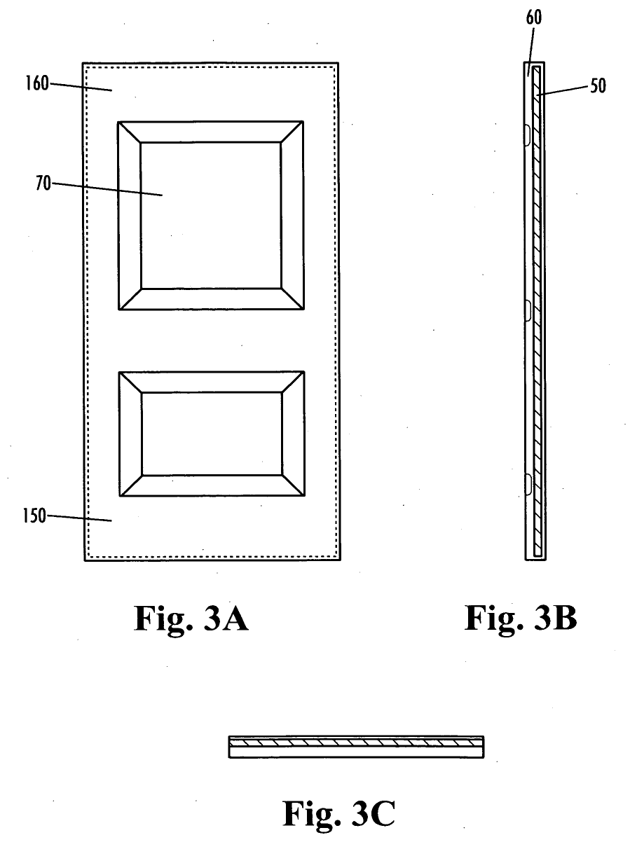

The shutter includes a wood structural panel 50 as shown in FIGS. 2B, 3B & 3C, 4B & 4C, and 5B & 5C. This panel should be rigid enough to aid in protecting the opening 20 of the structure 21 from damage during a storm. In the present invention, the wood structural panel 50 can be composed of any wood material known in the art. The wood structural panel 50 may be a plywood sheet, a particle board sheet, an oriented strand board, or an underlayment panel. Additionally, any combination of wood materials may be used in order to construct the wood structural panel 50. In a typical aspect, the wood panel is a plywood sheet.

The wood structural panel 50 may be of any thickness suitable for protecting the opening 20 of the structure 21 from storm damage when the shutter is closed over the opening. The thickness of the wood structural panel 50 may be between about 0.1 inches and about 2 inches. Optionally, the thickness of the wood structural panel 50 may be between about ¼ inches and about 1 inch, or between about ½ inches and 1 inch thick, or between about ½ inches and ¾ inches thick, or it can be about 7/16 inches thick, or about 15/32 inches thick.

The wood structural panel 50 may be constructed from any number of layers of wood. For example, the panel may be composed of two, three, four, five, six, or even more layers of wood that are glued together. In one aspect, the wood structural panel is plywood having multiple layers of thin wood sheeting where the layers are successively arranged such that the grain of the wood in adjacent layers is not parallel in order to give additional strength and rigidity to the panel. In one example, a single layer of 7/16 inch plywood, or 15/32 inch plywood, may be used as the wood structural panel 50 with the advantages of moderate weight, low cost, and compliance with building codes or exceptions to such codes for storm protection.

In the present shutter, the wood structural panel typically extends across the entire, or substantially entire, width of the shutter. The panel can, however, extend across the shutter in one piece, or the panel can be made up of two or more pieces laid edge to edge to form the wood structural panel 50. Pieces of various widths may be used for the production of the wood structural panel 50. An advantage of a preferred embodiment of the present shutter is that it avoids the use of side or top rails in construction of the shutter, although the shutter polymer coating can be configured to provide the appearance of such elements if desired, as will be discussed below in more detail.

The present shutter can be closed to protect an opening from damage by wind-borne debris, such as from a storm. In order to carry out this function, one shutter may be used to cover the opening to be protected, or two or more shutters may be used. When one shutter is used, such as with a Bahama shutter, it is common that the shutter covers the entire opening. In that instance, the shutter must be at least about the same width as the opening or slightly wider. In another common embodiment, two shutters flank either side of an opening. In that embodiment, each shutter must have a width that is at least about ½ of the width of the opening so that when the two shutters are closed, they cover the entire opening. When bi-fold shutters are used, it is common for each shutter to be at least about ¼ of the width of the opening. In this manner, the entire opening may be covered when the shutters are closed.

When the wood structural panel 50 is substantially the same width as the shutter, the wood structural panel 50 of the shutter may be between about 1/10 the width of the opening 20 and about the entire width of the opening 20, or more. Optionally, the wood structural panel 50 may be between about ¼ and about ¾ the width of the opening 20, or may be about ½ the width of the opening 20.

Additionally, the shutter 10 and the wood structural panel 50 that it comprises, may be of any length necessary to cover the opening when the shutter is closed. By way of example, the shutter may be slightly shorter than the length of the opening, so as to fit closely within the opening, or somewhat longer than the length of the opening, so as to completely cover the opening and overlap the structure 21 by an amount sufficient to permit connecting the shutter to the structure in a manner that will be discussed in detail below.

In the present shutter, a protective coating 60 can be applied to the wood structural panel 50 to form a surface of the shutter.

Commonly, the protective coating 60 may be applied to each side and all edges of the wood structural panel 50 to enclose the panel in the coating. If the protective coating is applied to each side and all edges of the wood structural panel, separate pieces of the protective coating may be connected together in order for the coating to cover the wood panel. The separate pieces of the protective coating may be connected by any method known in the art, for example, some suitable methods may include by glue, staples, nails, tacks, or brads The protective coating 60 may be applied to any portion of or to all of the wood structural panel 50. For example, the protective coating 60 may be applied to cover between about 1/32 to about the entire wood structural panel 50 (e.g., the front and back and all edges of the wood structural panel 50), or the protective coating 60 may substantially cover one side of the wood structural panel 50. If the protective coating 60 substantially covers one side of the wood structural panel 50, the protective coating 60 may cover either the back side 40 or the front side 30 of the panel.

The protective coating 60 may be applied in any thickness suitable for protecting the wood structural panel and/or for providing a decorative surface for the shutter. The protective coating 60 may be as thin as a layer of paint, or may be between about 0.1 inches and 2 inches in thickness. Optionally, the thickness of the protective coating 60 may be between about 0.2 inches and 1 inch, or between about 0.25 inches and 0.6 inches, or it may be between about 0.125 and about 0.25 inches thick. Due to the variation in molding techniques, which are discussed in more detail below, the density of the shutter 10 can also vary. For example, the density of the protective coating may be between about 5 lb/ft³ and about 30 lb/ft³, or may be between about 12 lb/ft³ and about 15 lb/ft³.

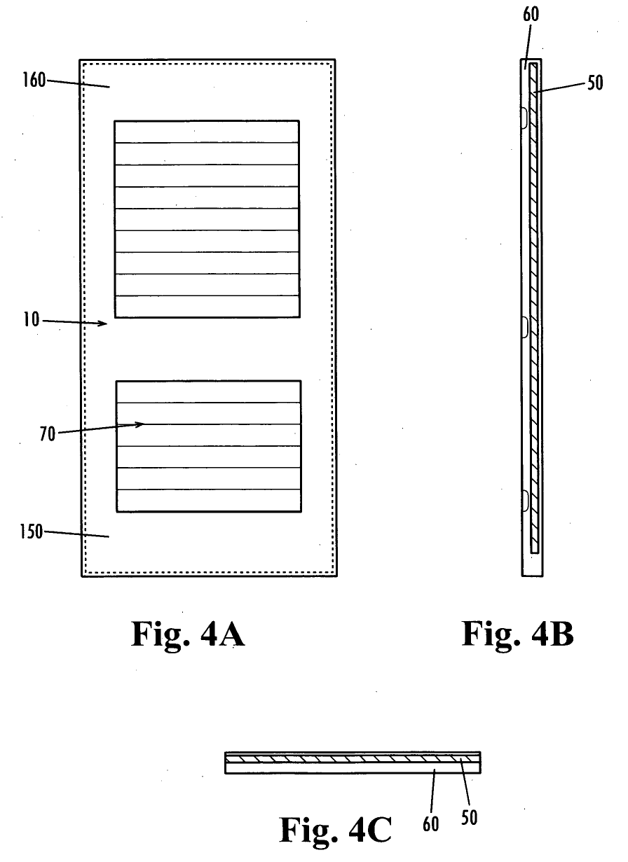

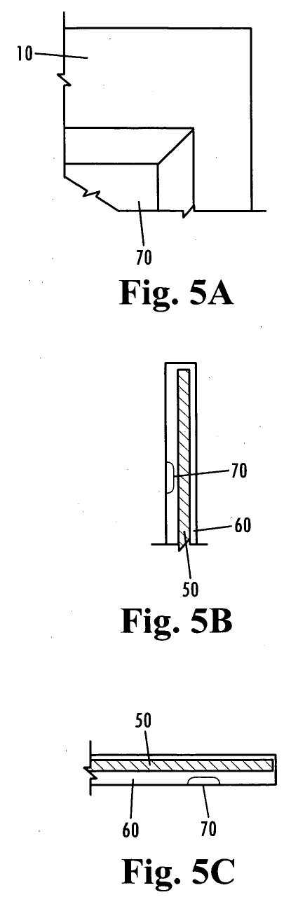

The novel shutter is designed so that it can remain attached to the structure when not closed to cover the opening. Therefore, it may be desirable for the protective coating 60 to include a surface configuration 70 having the appearance of a decorative shutter. When the surface configuration of the coating is discussed herein, what is meant is the topographical, color, or graphical design features of the surface of the coating on a side of the shutter. As used herein, the terms “decorative shutter” mean a shutter having the overall general visual appearance of a louvered shutter, a raised panel shutter, a joined board and batten shutter, a spaced board and batten shutter, a shutter having an ornamental design, or any other known colonial, plantation, or wooden shutter. The surface configuration may be applied to either side of the shutter 10 or to both sides. In one aspect, the surface configuration comprises a molded rigid polymer foam coating over a plywood panel where the coating has a surface configured to look like a conventional shutter. Any surface design known in the art may be utilized. For example, FIGS. 3A, 3B, & 3C depict embodiments where the shutter 10 contains a surface configuration having the appearance of a raised panel shutter. Further, FIGS. 4A, 4B, & 4C depict embodiments of the present invention where the shutter 10 contains a surface configuration having the appearance of a louvered shutter.

Purposes of the protective coating 60 include protecting the wood panel from weathering, rot, water-swelling, UV rays, and other environmental challenges and providing a pleasing decorative surface for the shutter. Any protective coating 60, therefore, can be utilized for the purposes listed. For example, the protective coating 60 may be a polymer coating and can optionally include a high tensile strength woven or non-woven fabric.

If a polymer coating is used as the protective coating 60, the polymer coating can be any type of polymer coating known in the art. Examples of useful coatings include paint, extruded foam, rigid polymer films, or any other polymer coating.

If a polymer is used for the protective coating 60, the polymer may comprise a polymer selected from the group consisting of ABS, cellulose triacetate, epoxy, polyacrylamide, polyacrylate, polyamide, polyamideimide, polybutylene terephthalate, polycarbonate, polyester, polyethylene, polyethylene terephthalate, polyimide, polymethyl (meth)acrylate, polyolefin, polystyrene, polyurethane, polyvinyl, polyvinyl alcohol, polyvinyl chloride, vinyl acetate, fiberglass and combinations thereof. Additionally, the polymer may be a rigid closed cell foam polymer that can be formed to have a smooth surface. Closed cell foams do not contain interconnected pores and normally have higher dimensional stability, low moisture absorption coefficient and higher strength compared to open cell structured foams.

In some embodiments, the polymer may be a rigid polyurethane foam. Polyurethane polymers are typically formed by reacting a polyisocyanate monomer with a polyamine or polyhydroxy monomer. Often a catalyst (sometimes referred to as an accelerator or initiator) is used to promote the reaction, and a blowing agent can be used if desired to form gas bubbles in the reacting resin to form a foam. Suitable examples of polyurethane reactive monomer systems are those provided by Carpenter Chemical Company under the trade names HAD-M200-31LC and HDB-650. However, any polyurethane that forms a rigid closed cell foam is suitable.

If a polymer coating is used for a protective coating 60, the polymer coating can be applied to the wood structural panel 50 in any way known in the art. For example, the polymer coating may be applied by a coating process selected from the group consisting of dip coating, rod coating, knife coating, blade coating, air knife coating, gravure coating, forward and reverse roll coating, slot and extrusion coating, slide coating and curtain coating, or combinations thereof. Optionally, the polymer coating may be applied by painting on the polymer, or by any type of molding method. Optionally, the polymer may be applied through a “foamed in mold” process. As used herein, “foamed in mold” shall refer to a process in which reactants suitable for forming a polymer, such as expandable polyurethane foam, are poured into a mold, the mold is closed, and the reactants react to form a rigid closed cell polymer structure.

As mentioned above, the protective coating 60 may include a high tensile strength fabric applied to the wood structural panel. A high tensile strength fabric aids in increasing the rigidity of the shutter 10 and strengthening the shutter against penetration by windblown objects. In some instances a high tensile strength fabric may be used in combination with a polymer coating to form the protective coating 60. The high tensile strength fabric may be a woven or non-woven material, preferably made of a high-tensile fiber material. It is preferred that the high tensile strength fabric used for the present invention be one having a tensile breaking strength not less than about 100 pounds per inch of fabric width for every ounce per square yard of material. The tensile breaking strength shall refer to the stress coordinate on the stress-strain curve at the point of rupture.

Any high tensile strength fabric or combination of high tensile strength fabrics can be optionally included in the protective coating. For example, the high tensile strength fabric may be made from aramid fibers, such as those sold under the trademark KEVLAR®, or from ultra-high molecular weight polyethylene fibers, such as those sold under the trademarks SPECTRA® and DYNEEMA®, or from polyphehylenebenzobisoxazole (PBO) fibers, such as those sold under the trademark ZYLON®. Also, the high tensile strength fabric may be a mesh, formed from, for example, polyester, glass and/or nylon fibers which may or may not have a vinyl coating. A suitable example of high tensile strength fabric is a mesh formed from polyester such as those made by Phifer Inc., Tuscaloosa, Ala., and sold under the trademark PETSCREEN™. If a mesh is used as a high tensile strength fabric it is preferred that the mesh size be less than about 3/16 inch in order to meet the requirements of the ASTM Small Missile Test.

If the protective coating 60 includes a high tensile strength fabric, an adhesive may optionally be used in order to aid in applying the fabric to the wood structural panel 50. In certain instances where a fabric and a polymer coating are used together to form the protective coating 60, it may be beneficial to place the adhesive only on the side of the fabric that comes in contact with the wood structural panel. Suitable adhesives include those known in the art that will aid in adhering the high tensile strength fabric to the wood structural panel, while causing little or no interference with the polymer coating.

As discussed above, the high tensile strength fabric may add rigidity to the shutter for increased protection during a storm. The use of a protective coating that includes a high tensile strength fabric in combination with a polymer coating, in some embodiments, may be sufficient to meet the requirements of the ASTM E1886 and ASTM E 1996 tests. The present invention, therefore, is able to meet the requirements of windborne debris protective devices without the high costs as compared to other shutters in the marketplace.

The invention optionally further includes mounting fittings 90 for swingably attaching the shutter 10 to the structure 21 adjacent the opening 20 such that when the shutter is closed to cover the opening 20, the shutter 10 covers all or a portion of the opening 20 and, when open, the shutter 10 remains attached to the structure in a location that is adjacent the opening 20. As previously discussed, the height and length of the wood structural panel 50 may vary, and the size of the wood structural panel 50 will dictate the degree to which the shutter 10 covers the opening 20 of the structure 21.

Swingably attaching the present shutter to the structure allows for the shutter to remain attached to the structure when it is not closed to cover the opening that it is designed to protect. It is well known in the art to use channels to slide a protective panel over an opening when there is a need for protection as shown in U.S. Pat. Nos. 5,603,190 and 5,740,639, among others, and the present shutter can be used in such channels. These designs, however, require that the user lift and install the panels into the channels when mounting the panels for protection, which can be difficult based on the weight and shape of the panels. Additionally, the channels, which remain on the structure while the protective panels are not in use, can be difficult to include in a pleasing architectural effect.

The mounting fittings 90 allow the shutter to easily open and close over the opening and may comprise either male or female hinge portions located on the shutter in a position to engage mating hinge portions affixed to the structure. Any mounting fittings 90 known in the art may be utilized.

The shutter may be swingably attached to the structure at a location where it can be closed to cover any portion of the opening. For example, if the present shutter is installed as a Bahama shutter, it may be swingably attached to the structure at the top latitudinal side of the opening. Another common embodiment is placing a shutter on either side of an opening. In this aspect, each of the two shutters is swingably attached to an opposing longitudinal side 100 of the opening. The mounting fittings, therefore, may be placed on either the longitudinal or latitudinal sides of the opening as necessary for the desired shutter mounting location. Optionally, the mounting fittings may be placed on both the longitudinal and latitudinal sides of the opening.

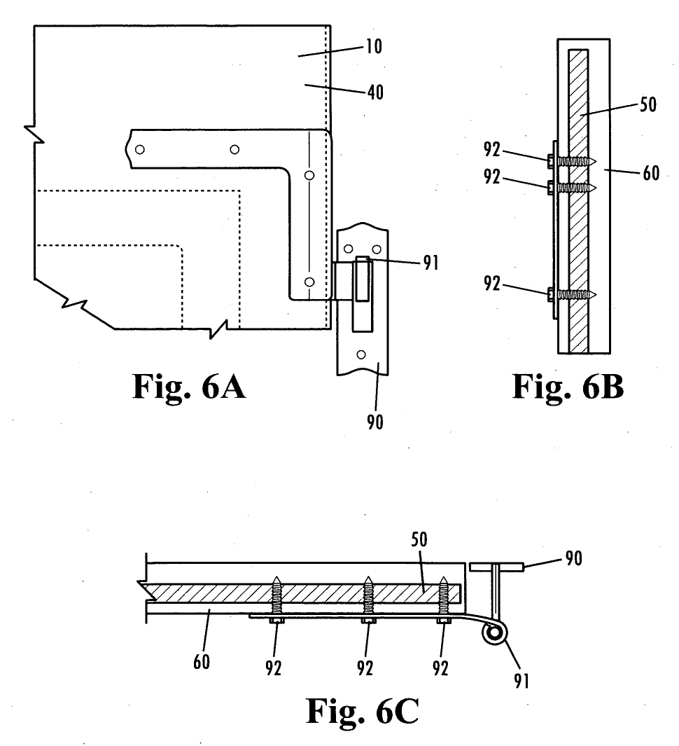

In order to allow the shutter 10 to move from an open position to a closed position, a hinge 91 may be utilized as the mounting fitting. Any type of hinge that is known in the art may be used and is contemplated by the present invention. An example of an embodiment where pintle hinges are used for mounting fittings is shown in FIGS. 2 and 6. FIG. 6 illustrates embodiments of the present invention where hinge connecting screws 92 pass through holes in the hinge 91 and into the shutter 10 as a method of affixing the hinges to the shutter. Other examples of suitable hinges include, for example, a New York style hinge, a swing clear shutter hinge, a full mortise hinge, a pintle shutter hinge, a Connecticut style shutter hinge, an “L” type shutter hinge, a Suffolk hinge, and a MS hinge. By way of example, shutter hinges, such as those described in U.S. Patent Application Publication No. 2007/0143961, are useful as mounting fittings for the present invention.

When the shutter is in the open position, a retaining device may be utilized in order to maintain the shutter in place. The retaining device may be connected to the structure 21 or, possibly, to the shutter 10, or to both. The retaining device 80 may be any device or combination of devices known in the art for the purpose of maintaining the shutter in place. Suitable retaining devices 80 may include one or more of the following: a hook, a hook and ring, two hooks, a rotatable lug, any number of nails, and any number of screws.

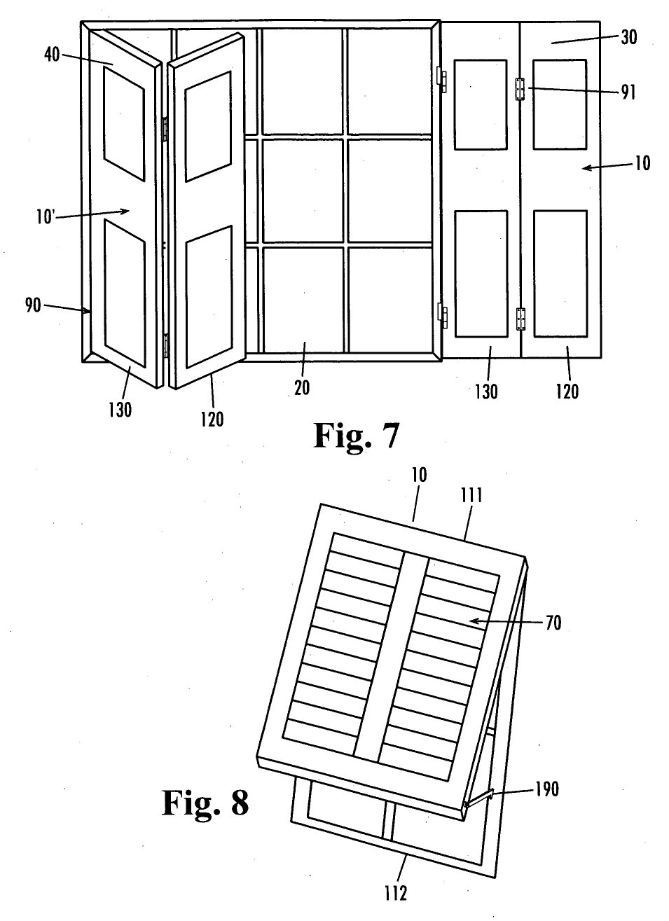

In some embodiments of the invention, the shutter 10 may be a bi-fold shutter. An example of such an embodiment is shown in FIG. 7. In embodiments of the invention where the shutter 10 is a bi-fold, at least two shutters 120 and 130 may be used and connected to one another. A second shutter 120 may be swingably attached, in the same manner as discussed above, to a first shutter 130 on the front side 30 of both the first shutter 130 and the second shutter 120. In further embodiments of the invention where the shutter 10 is a bi-fold, a second shutter 120 may be swingably attached to a first shutter 130 on the back side 40 of both the first and second shutters. In embodiments where the shutter 10 is a bi-fold, the shutters 120 and 130 comprise a wood structural panel 50 with a protective coating 60 applied to the wood structural panel 50 in the same manner as described earlier.

An important optional feature of the present shutter is the incorporation of one or more connectors 170 to secure the shutter to the structure in a closed position covering the opening. As used herein in conjunction with the step of securing or attaching the shutter to the structure in a closed position covering all or a part of the opening, the term “connectors” is intended to include all parts or pieces necessary for that attachment. The connectors 170 can be, for example, screws or nails, that pass through holes in the shutter and seat into the structure, or can be threaded lugs or studs permanently anchored in the structure which mate with and extend through holes in the shutter when the shutter is closed and which secure the closed shutter with nuts, or can be anchors having internal threads which mate with holes in the shutter when the shutter is closed and which secure the closed shutter with threaded bolts or screws that pass through the shutter and seat into the anchors. Alternately, the connectors 170 can be telescoping or sliding bars mounted on the shutter which deploy into mating brackets or seats affixed to the structure such as those described in U.S. Pat. Nos. 6,363,670, 5,507,118, 6,371,422, or 5,579,604, or can be one or more lever arms that lock into grooves in the structure as shown in U.S. Pat. No. 6,334,282. Preferably, the connectors are devices that can be repeatedly installed to secure the closed shutter and removed to allow the shutter to return to an open position without damaging the structure or the shutter. Additionally the connectors used in the present invention can be of varying sizes, including, by way of example, variations in length and width.

The present connectors permit the secure attachment of the shutter to the structure without the necessity of applying a grid or support system to the structure as shown in U.S. Pat. Nos. 5,722,206 and 5,852,903, among others. Therefore, the present invention permits the secure attachment of a code-compliant shutter that is free of a permanent or removable grid that covers part of the opening to be protected while the shutter is not closed to cover the opening.

Several optional embodiments of the present connectors will now be described in more detail. In one alternate, the connectors 170 comprise wood screws or nails that pass through predrilled holes in the shutter and secure the shutter to the structure. When the span of the shutter(s) is not over 8 feet, the wood screws can be 2½ inch No. 6 wood screws or 2½ inch No. 8 wood screws and nails can be double headed 10d common or double-headed 12d box nails. By “span of the shutter(s)”, what is meant is the longer of the width or the height of the shutter. The connectors are installed at opposing ends of each shutter. By “opposing ends”, it is meant the area within about 6 inches of each end, and preferably within about 4 inches, of the longer of the width or the length of the shutter. Typically, the connectors are installed in that part of the shutter that overlaps the structure.

Typically, connectors 170 are spaced along the opposing ends of each shutter. When the connectors are 2½ inch No. 6 wood screws, the connectors are preferably spaced apart along each edge no more than 16 inches when the shutter has a span of 2 feet or less, or no more than 16 inches when the shutter has a span of between 2 feet and 4 feet, or no more than 12 inches when the shutter has a span of between 4 feet and 6 feet, and no more than 9 inches when the panel has a span between 6 feet and 8 feet. When the connectors are 2½ inch No. 8 wood screws, the connectors are preferably spaced apart along each edge no more than 16 inches when the shutter has a span of 2 feet or less, or no more than 16 inches when the shutter has a span of between 2 feet and 4 feet, or no more than 16 inches when the shutter has a span of between 4 feet and 6 feet, and no more than 12 inches when the panel has a span between 6 feet and 8 feet. When the connectors are 2½ inch No. 10 wood screws, the connectors are preferably spaced apart along each edge no more than 16 inches when the shutter has a span of 2 feet or less, or no more than 16 inches when the shutter has a span of between 2 feet and 4 feet, or no more than 12 inches when the shutter has a span of between 4 feet and 6 feet, and no more than 9 inches when the panel has a span between 6 feet and 8 feet. When the connectors are 10d common or 12d box double-headed nails, the connectors are preferably spaced apart along each edge no more than 12 inches on center (o.c.) when the shutter has a span of 2 feet or less, or no more than 6 inches o.c. when the shutter has a span of between 2 feet and 4 feet, or no more than 4 inches o.c. when the shutter has a span of between 4 feet and 6 feet, and no more than 3 inches o.c. when the panel has a span between 6 feet and 8 feet.

In some applications where wood screws are used as the connectors, they are provided with appropriately sized wood screw based anchors having 2-inch embedment length. The anchors are installed in the structure at locations appropriate for the connector spacing described above.

Where the connectors are screws, and the structure into which the screws will seat is masonry or masonry/stucco, the screws can be attached utilizing vibration resistant anchors having a minimum withdrawal capacity of 490 pounds.

In some applications, it is useful that the connectors are constructed of corrosion resistant materials.

Typically, the present shutters can be provided with all connectors required for anchoring the shutter to the structure in a closed position to cover the opening. If the connectors require holes in the shutter, the shutter can be provided with pre-drilled holes in appropriate locations for attachment of the connectors.

The connector 170 may also be a threaded lug bolt or stud anchored in the structure, which passes through a pre-drilled hole in the shutter when in a closed position and secures the shutter with a nut. A washer may be used in connection with any connector as known in the art.

A storm bar may also be used as a connector. A storm bar is connected to the structure and placed over the closed shutter to ensure that the opening is protected. The storm bar may be adjustable, or may be rigid. The storm bar can be made from any material known in the art with some examples including steel, fiberglass, wood, or aluminum. The storm bar may also serve as a joining device, as discussed below, or may serve as both a joining device and as a connector.

In some situations, multiple different connectors may be used to properly attach the shutter to the structure. For example, the method may include a storm bar as well as threaded studs and nuts as connectors.

If holes 140 are placed in the wood structural panel 50, the holes align with locations where connectors are to seat into the structure for releasably attaching the shutter 10 to the structure 21 for the purpose of securing the shutter to the structure in a closed position. As used herein, the terms “securing the shutter directly to the structure” means that the shutter abuts the structure, either covering the opening or fitting closely within the opening, and the shutter is connected to the structure without being connected to intervening objects, such as support rods, grids, or other intervening objects known in the art.

In another aspect, the invention is directed to a method for protecting an opening 20 of a structure 21 from wind gusts and wind-borne debris resulting from wind gusts up to about 130 miles per hour, or even up to 150 miles per hour. The method comprises covering the opening 20 with the previously discussed shutter 10, an embodiment of which is illustrated in FIG. 4. In some embodiments, the method protects the previously discussed opening 20 of a structure 21 from wind gusts and wind borne debris resulting from wind gusts up to about 130 miles per hour.

The method may utilize any number of shutters 10 on any side of the opening 20. For example, the method may utilize a shutter 10 placed on both longitudinal sides of the opening. In such situations, each shutter 10 may have a width of about one-half of the opening 20 and have the same dimensions as the other shutter. In embodiments such as these, a joining device 180 may be used to join the shutters 10 together when they are closed. Any joining device 180 known in the art may be utilized. Examples of joining devices that are useful in the present invention include one or more of a hook and knob, two hooks, two knobs in combination with rope or string, a spring keeper and a post, a rotatable lug, a storm bar, or a hook and a ring.

The method may also include at least one shutter 10 placed adjacent to the upper latitudinal 111 side of the opening. This placement is commonly referred to as a Bahama shutter, and an example is shown in FIG. 8. Additionally, when a Bahama shutter is used, an elevating device 190 may also be utilized for elevating the shutter 10 away from the lower latitudinal side 112 of the opening. Any known elevating device may be utilized. For example, some suitable elevating devices could include one or more of a single piece of metal, multiple pieces of metal connected by a hinge or other connecting device, a single piece of wood, multiple pieces of wood connected by a hinge or other connecting device, string, rope, and a Bahama hook utilized with an eye screw

In another aspect, the invention is directed to a method for storing a protective shutter 10. The method comprises swingably attaching the previously described shutter 10 that comprises a wood structural panel 50, and a protective coating 60 that includes a surface configuration having the appearance of a decorative shutter, applied to the wood structural panel 50 adjacent an opening 20 of a structure 21 such that it can remain adjacent to the opening 20 when the shutter 10 is not in a closed position covering the opening. In this aspect of the invention the shutter 10 contains the previously discussed mounting fittings 90.

In another aspect, the invention is directed to a method for making a protective shutter 10 for an opening 20 of a structure 21, the method includes applying a protective coating 60 such as those discussed above to a wood structural panel 50 such as those discussed above. The protective coating 60 and the wood structural panel 50 are the same as those referenced above.

For example, the method of making the shutter could include pouring a measured amount of polymerization reactants into a mold. Silicone molds are suitable for use in this application, because they can be removed from the cured molded piece with minimum damage to the product. The silicone mold typically is in the form of a negative of the surface configuration that is desired for the particular shutter being produced. If desired, the silicone mold may be coated with a release compound, such as those known in the art, which aids the release of the molded article and may also act as a primer if the shutter is later to be painted. The wood structural panel may then be placed on top of the liquid reactants in the mold and another measured amount of polymerization reactants may be poured over the top of the wood structural panel in the mold. A release paper may then be added over the reactants and the mold placed in a press to cure. The press allows the polymer to foam and cure into a rigid closed cell form with a smooth surface skin where it is in contact with the mold. The mold may then be removed from the press, and the shutter may be taken out of the mold. The side of the shutter which contains release paper may optionally be machined or sanded to remove the paper and to obtain the desired thickness and surface finish for the back side of the shutter. The shutter can be cleaned to remove sprues unwanted polymer, and optionally, can be further processed, such as by painting.

In the process described above, it is desirable that the wood structural panel 50 be dry and free of oil in order for the polymer to properly coat and adhere to the panel. Additionally, it may be desirable in some embodiments, to used measured amounts of polymerization reactants under and over the wood panel so that the coating forms with relatively equal thickness on the front side and the back side of the panel in order to prevent warping or bowing of the shutter 10. In a typical molding method, the wood panel is placed in the silicone mold and about ⅛″ is left between each lateral edge of the panel and the interior of the mold, and about ¼″ is left between the top and bottom edges of the panel and the interior of the mold. The measured amount of polymerization reactants that are applied under and over the top of the panel in the mold can be sufficient to provide a cured shutter having a protective coating of about 3/16″ thickness on the front side and the back side of the shutter.

### Example 1

A shutter comprising plywood covered with a high tensile strength woven fabric and expandable polyurethane foam formed in accordance with the present invention was placed over an opening of a structure. The shutter was secured with four #12-14×2-½ inch Hex Washer Head Sheet Metal Screws each with a 1-¼ inch OD flat washer, two approximately 1-½ inches from the top of the shutter, and two approximately 1-½ inches from the bottom of the shutter. Two 9 lb. 2×4 pieces of wood, which were approximately 8 feet long, were propelled at the shutter at a velocity of about 50 feet/second to emulate wind-borne debris. The shutter maintained its structure and successfully protected the opening from the debris. These results demonstrate that the shutter is sufficient to meet the requirements of the ASTM E1886 and ASTM E 1996 tests.

### Example 2

A shutter comprising plywood covered with a high tensile strength woven fabric and expandable polyurethane foam formed in accordance with the present invention was placed over an opening of a structure. The shutter was mounted to the structure on its longitudinal side by NY Style L-hinges and a pintle. The shutter covered half of the opening and was held in place by a fiberglass storm bar. The fiberglass storm bar covered the distance of the opening of the structure horizontally and was connected to the shutter at both the left side and right side of the shutter and on the structural frame where there was no shutter. Two 9 lb. 2×4 pieces of wood, which were approximately 8 feet long, were propelled at the shutter at a velocity of about 50 feet/second to emulate wind-borne debris. The shutter maintained its structure and successfully protected the opening from the debris. These results demonstrate that the shutter is sufficient to meet the requirements of the ASTM E1886 and ASTM E 1996 tests.

### Example 3

Two shutters comprising plywood covered with a high tensile strength woven fabric and expandable polyurethane foam in accordance with the present invention were placed over opposite sides of an opening of a structure, thereby covering the entire opening. The shutters were mounted to the structure on their longitudinal side by NY Style L-hinges and a pintle. The shutters were held together by a fiberglass storm bar that connected at the right and left side of each shutter. Three 9 lb. 2×4 pieces of wood, which were approximately 8 feet long, were propelled at the shutter at a velocity of about 50 feet/second to emulate wind-borne debris. The shutter maintained its structure and successfully protected the opening from the debris. These results demonstrate that the shutter is sufficient to meet the requirements of the ASTM E1886 and ASTM E 1996 tests.

As various changes could be made in the above methods and compositions by those of ordinary skill in the art without departing from the scope of the invention, it is intended that all matter contained in the above description and shown in the accompanying drawings shall be interpreted as illustrative and not in a limiting sense. Skilled artisans will recognize that the given examples have many alternatives that fall within the scope of the invention. In addition it should be understood that aspects of the various embodiments may be interchanged both in whole or in part.

What is claimed is:

1. A storm resistant shutter having a front side and a back side and comprising:
a wood structural panel; and
a protective coating that includes a surface configuration having the appearance of a decorative shutter.

2. The shutter of claim 1 further comprising mounting hardware for attaching the shutter to the structure.

3. The shutter of claim 2 wherein the mounting hardware comprises mounting fittings that are attached to the shutter and located for swingably attaching the shutter to the structure such that the shutter can be positioned in an open position and in a closed position covering the opening.

4. The shutter of claim 1, further comprising one or more connectors for releasably securing the shutter to the structure in a closed position covering the opening.

5. The shutter of claim 1, wherein the wood structural panel is selected from the group consisting of: plywood, particle board, oriented strand board, underlayment panel, and combinations thereof.

6. The shutter of claim 1, wherein the width of the wood structural panel is at least ½ the width of the opening to be protected.

7. The shutter of claim 1, wherein the width of the wood structural panel is equal to or greater than the width of the opening to be protected.

8. The shutter of claim 1, wherein the length of the wood structural panel is equal to or greater than the height of the opening to be protected.

9. The shutter of claim 1, wherein the wood structural panel has a thickness of at least about ½ inches.

10. The shutter of claim 1, wherein the wood structural panel has a thickness of at least about 7/16 inches.

11. The shutter of claim 1, wherein the wood structural panel comprises 7/16 inch thick plywood.

12. The shutter of claim 1, wherein the protective coating substantially covers at least one side of the wood structural panel.

13. The shutter of claim 3, wherein the shutter has a front side that faces the structure when the shutter is closed and a back side that faces the structure when the shutter is open and the protective coating is applied to the front side of the shutter.

14. The shutter of claim 1, wherein the protective coating substantially encases the wood structural panel.

15. The shutter of claim 1, wherein the protective coating comprises a molded surface configuration of a decorative shutter selected from: raised panel, flat panel, louvered, board and batten, board without batten, bahama, shaker, solid raised, solid molded, or any combination thereof.

16. The shutter of claim 13, wherein the protective coating substantially encases the wood structural panel and includes the surface configuration of a decorative shutter on one or both of the front side or the back side of the shutter.

17. The shutter of claim 1, wherein the protective coating comprises a polymer.

18. The shutter of claim 17, wherein the polymer coating comprises a polymer selected from the group consisting of ABS, cellulose triacetate, epoxy, polyacrylamide, polyacrylate, polyamide, polyamideimide, polybutylene terephthalate, polycarbonate, polyester, polyethylene, polyethylene terephthalate, polyimide, polymethyl (meth)acrylate, polyolefin, polystyrene, polyurethane, polyvinyl, polyvinyl alcohol, polyvinyl chloride, vinyl acetate, and combinations of these.

19. The shutter of claim 1, wherein the protective coating comprises a high tensile strength fabric.

20. The shutter of claim 19, wherein the high tensile strength fabric is made from a member of the group consisting of aramid fibers, ultra-high molecular weight polyethylene fibers, polyphehylenebenzobisoxazole (PBO) fibers, polyester fibers, glass fibers, nylon fibers, and combinations of these.

21. The shutter of claim 1, wherein the protective coating comprises a polymer coating and a high tensile strength fabric.

22. The shutter of claim 3, further comprising a retaining device for securing the shutter to the structure when the shutter is open.

23. The shutter of claim 1, wherein the shutter is a bi-fold shutter, comprising:
a first shutter; and
a second shutter swingably attached to the first shutter.

24. The shutter of claim 3, wherein the mounting fittings comprise male or female hinge portions located to engage complementary hinge portions affixed to the structure.

25. The shutter of claim 4, wherein the connectors comprise holes pre-drilled in the shutter near opposing ends of the longer of the length or the width of the shutter.

26. The shutter of claim 25, wherein the connectors further comprise 2½ inch No. 6 wood screws, 2½ inch No. 8 wood screws, 2½ inch No. 10 wood screws, 10d common double headed nails, 12d box double headed nails, 2½ inch No. 12 sheet metal screws, 2½ inch No. 14 sheet metal screws, or any combination thereof.

27. The shutter of claim 25, wherein when the shutter is in a closed position covering the opening, the pre-drilled holes align with locations in the structure for anchoring the connectors for releasably attaching the shutter to the structure.

28. The shutter of claim 25, wherein the connectors comprise threaded studs or threaded anchors permanently seated in the structure.

29. A shutter for protecting an opening of a structure, the shutter having a front side that faces toward the structure and a back side that faces away from the structure when the shutter is closed to protect the opening, the shutter comprising:
a plywood panel having a width that is at least ½ of the width of the opening and which is longer than the opening and a thickness of between about 7/16 inches and 15/32 inches;
a protective coating comprising rigid polyurethane foam and a mesh formed from polyester fibers that encloses the plywood panel and has a surface configuration having the appearance of a decorative shutter; and
mounting fittings that are attached to the shutter and located for swingably attaching the shutter to the structure such that the shutter can be positioned in both an open position and in a closed position covering the opening; and
one or more connectors for releasably securing the shutter to the structure in a closed position covering the opening.

30. A method for protecting an opening of a structure from wind gusts and wind-borne debris, the method comprising:
swingably attaching to the structure a shutter that can be positioned in both an open position and a closed position to at least partially cover the opening, wherein the shutter has:
a front side that faces toward the structure and a back side that faces away from the structure when the shutter is closed to protect the opening;
a wood structural panel having a width that is at least ¼ of the width of the opening to be protected and a thickness of between about 0.5 and 1 inches; and
a protective coating applied to at least one side of the wood structural panel;
closing the shutter to at least partially cover the opening; and
securing the shutter directly to the structure with at least one connector so that the shutter covers at least a portion of the opening when the shutter is closed.

31. The method of claim 30, wherein shutters are placed on either side of the opening.

32. The method of claim 30, wherein the opening is a window.

33. The method of claim 30, wherein the shutters are swingably attached to the shutter with mounting fittings.

34. A method of storing a shutter for protecting an opening of a structure, the method comprising:
providing a shutter which comprises:
a wood structural panel;
a protective coating that includes a surface configuration having the appearance of a decorative shutter;
mounting fittings for swingably attaching the shutter adjacent the opening;
swingably attaching the shutter adjacent an opening of a structure in a location that it remains adjacent to the opening when the shutter is not closed to cover the opening; and
securing the shutter in an open position.

35. A method of producing a storm resistant shutter, the method comprising:
providing a wood structural panel having a front side and a back side; and
applying a protective coating to the panel, wherein the coating includes a surface configuration having the appearance of a decorative shutter.

36. The method of claim 35, further comprising providing one or more connectors for releasably securing the shutter to the structure in a closed position covering the opening.
